(19) United States
(12) Patent Application Publication
(10) Pub. No.: US 2006/0162388 A1
(43) Pub. Date: Jul. 27, 2006

(54) Composite mold and method for making the same

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-Cheng City (TW)

(21) Appl. No.: 11/322,091

(22) Filed: Dec. 29, 2005

(30) Foreign Application Priority Data
Jan. 14, 2005 (TW) 94101093

(51) Int. Cl. C03B 11/08; B28B 3/00; C04B 35/64

(52) U.S. Cl. 65/374.11; 65/374.13; 264/603

(57) ABSTRACT

A composite mold has a composite structure defining a molding surface having a desired shape. The composite structure is comprised of a sintered material formed by sintering a mixture that includes tungsten carbide particles and carbon nanocapsules. Preferably, the mixture further includes noble metal particles. A method for making a composite mold includes the steps of: providing a first mold having a desired shape; placing a mixture comprising carbon nanocapsules and tungsten carbide particles into the first mold; and sintering the mixture of carbon nanocapsules and tungsten carbide particles, thereby forming a composite mold having a composite structure and defining a molding surface.

### TECHNICAL FIELD

The present invention relates to a mold for molding glass articles, and more particularly relates to a composite mold and a method for making the mold.

### BACKGROUND

Glass optical articles, such as aspheric lenses, ball-shaped lenses, prisms, etc. are generally made by a direct press-molding process using a mold. The glass optical articles obtained by the direct press-molding method advantageously do not need to undergo further processing, such as a polishing process. Accordingly, the manufacturing efficiency can be greatly increased. However, the mold used in the direct press-molding method has to satisfy certain critical requirements such as high chemical stability, resistance to heat shock, good mechanical strength, and good surface smoothness.

Several criteria that should be considered in choosing the material for making the mold are listed below:
a. the mold formed from such material is rigid and hard enough so that the mold cannot be damaged by scratching and can withstand high temperatures;
b. the mold formed from such material is highly resistant to deformation or cracking even after repeated heat shock;
c. the mold formed from such material does not react with or adhere to the glass material at high temperatures;
d. the material is highly resistant to oxidization at high temperatures;
e. the mold formed of such material has good machinability, high precision, and a smooth molding surface; and
f. the manufacturing process using the mold is cost-effective.

In earlier years, the mold was usually made of stainless steel or a heat resistant metallic alloy. However, such mold typically has the following defects. Sizes of crystal grains of the mold material gradually become larger and larger over a period of time of usage, whereby the surface of the mold becomes more and more rough. In addition, the mold material is prone to being oxidized at high temperatures. Furthermore, the glass material tends to adhere to the molding surface of the mold.

Therefore, non-metallic materials and super hard metallic alloys have been developed for making molds. Such materials and alloys include silicon carbide (SiC), silicon nitride (Si₃N₄), titanium carbide (TiC), tungsten carbide (WC), and a tungsten carbide-cobalt (WC-Co) metallic alloy. However, SiC, Si₃N₄ and TiC are ultrahard ceramic materials. It is difficult to form such materials into a desired shape, especially an aspheric shape, with high precision. Further, WC and a WC-Co alloy are liable to be oxidized at high temperatures. All in all, these materials are not suitable for making high-precision molds.

Thus, a composite mold comprising a mold base and a protective film formed thereon has been developed. The mold base is generally made of a carbide material or a hard metallic alloy. The protective film is usually formed on a molding surface of the mold base.

Typically, the mold base of the composite mold is made of a hard metallic alloy, a carbide ceramic, or a metallic ceramic. The protective film of the composite mold is formed of a material selected from the group consisting of iridium (Ir), ruthenium (Ru), an alloy of Ir, platinum (Pt), rhenium (Re), osmium (Os), rhodium (Rh), and an alloy of Ru, Pt, Re, Os and Rh. Furthermore, a diamond like carbon (DLC) film is also used as the protective film.

However, the wear resistance of the mold is still not ideal. After a period of repeated usage, the protective film is liable to peel off from the mold base. Therefore, the quality of the glass products formed may be diminished, and the service lifetime of the mold may be shortened.

Therefore, a mold with high wear resistance and long service lifetime is desired.

### SUMMARY

A composite mold has a composite structure comprised of a sintered material formed by sintering a mixture comprising tungsten carbide particles and carbon nanocapsules. The composite structure has a molding surface with a desired shape.

A percentage by weight of the carbon nanocapsules in the mixture is generally configured to be in the range from 1% to 25%, and preferably in the range from 1% to 13%. The carbon nanocapsules are hollow or filled with metal particles. Particle sizes of the carbon nanocapsules are in the range from 1 nm to 100 nm, and preferably in the range from 30 nm to 40 nm.

Preferably, the mixture further comprises noble metal particles. A percentage by weight of the noble metal particles in the mixture is generally configured to be in the range from 1% to 25%, and preferably in the range from 1% to 13%. The particle sizes of the noble metal particles are in the range from 1 nm to 100 nm. The noble metal particles may be selected from the group consisting of Pt, Re, Ir, and alloys thereof.

A method for making a composite mold comprises the steps of: providing a first mold having a desired shape; placing a mixture comprising carbon nanocapsules and tungsten carbide particles into the first mold; and sintering the mixture of carbon nanocapsules and tungsten carbide particles, thereby forming a composite mold having a composite structure with a molding surface. The first mold is made of a hard metallic alloy. A percentage by weight of the carbon nanocapsules in the mixture is generally configured to be in the range from 1% to 25%, and preferably in the range from 1% to 13%. The carbon nanocapsules are hollow or filled with metal particles. Particle sizes of the carbon nanocapsules are in the range from 1 nm to 100 nm, and preferably in the range from 30 nm to 40 nm.

Preferably, the mixture further comprises noble metal particles. A percentage by weight of the noble metal particles in the mixture is generally configured to be in the range from 1% to 25%, and preferably in the range from 1% to 13%. The particle sizes of the noble metal particles are in the range from 1 nm to 100 nm. The noble metal particles may be selected from the group consisting of Pt, Re, Ir, and alloys thereof.

In addition, the method for making a composite mold may further comprise the step of micro-machining the molding surface according to a desired shape of the final molded product.

The composite mold has a composite structure made of a sintered material formed by sintering a mixture comprising carbon nanocapsules and tungsten carbide particles. Therefore the composite mold has high hardness, and the process for making the composite mold is simplified. In addition, due to the carbon nanocapsules provided in the composite structure, the following further advantages are obtained. The wear resistance of the composite mold is enhanced, and the molding surface has good workpiece release performance. Thus, chipping and peeling of the composite mold are avoided, with there being no need for an additional protective layer. Furthermore, due to the noble metal particles provided in the composite structure, good surface smoothness of the composite mold is obtained, and the workpiece release performance is improved.

Other advantages and novel features will become more apparent from the following detailed description when taken in conjunction with the accompanying drawings.

### BRIEF DESCRIPTION OF THE DRAWINGS

Many aspects of a composite mold and a method for making the same can be better understood with reference to the following drawings. The components in the drawings are not necessarily to scale, the emphasis instead being placed upon clearly illustrating the principles of the composite mold and the method for making the same. Moreover, in the drawings, like reference numerals designate corresponding parts throughout the several views.

FIG. 1 is a schematic, cross-sectional view of a composite mold in accordance with a first embodiment of the present invention.

FIG. 2 is a schematic, cross-sectional view of a composite mold in accordance with a second embodiment of the present invention.

### DETAILED DESCRIPTION OF THE EMBODIMENTS

The present invention is further described below including by reference to the figures.

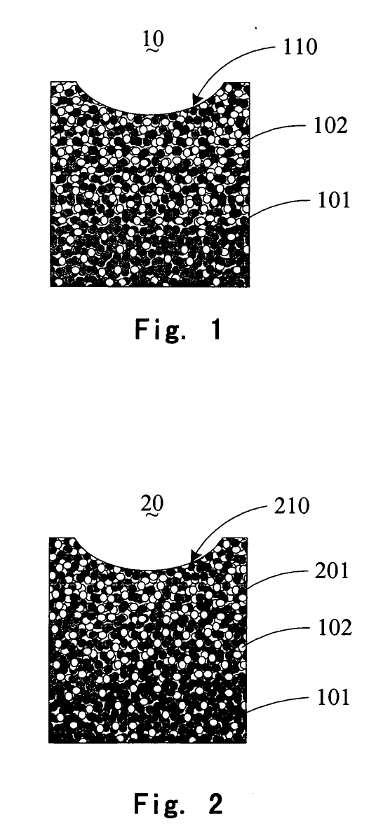

Referring to FIG. 1, a composite mold 10 according to a first embodiment of the present invention is shown. The composite mold 10 is for molding a glass article, for example a glass optical lens. The composite mold 10 is made of a sintered material formed by sintering tungsten carbide particles 101 and carbon nanocapsules 102. The composite mold 10 comprises a molding surface 110 having a desired shaped according to a glass article to be made; for example a glass optical lens.

A percentage by weight of the carbon nanocapsules 102 in the sintered material is generally configured to be in the range from 1% to 25%, and preferably in the range from 1% to 13%. The carbon nanocapsules 102 are hollow or filled with metal particles. The carbon nanocapsules 102 have many superior characteristics such as low weight, high surface area, high hardness, high chemical stability, high wear resistance, and high thermal/electrical conductivity. Particle sizes of the carbon nanocapsules 102 are in the range from 1 nm to 100 nm, and preferably in the range from 30 nm to 40 nm.

Referring to FIG. 2, a composite mold 20 according to a second embodiment of the present invention is shown. The composite mold 20 is similar to the composite mold 10 of the first embodiment. However, the composite mold 20 is made of a sintered material formed by sintering tungsten carbide particles 101, carbon nanocapsules 102, and noble metal particles 201.

A percentage by weight of the noble metal particles 201 in the sintered material is generally configured to be in the range from 1% to 25%, and preferably in the range from 1% to 13%. The particle sizes of the noble metal particles 201 are in the range from 1 nm to 100 nm. The noble metal particles 201 may be selected from the group consisting of Pt, Re, Ir, and alloys thereof.

It is to be noted that, in addition to molding glass articles, the composite mold 10 and composite mold 20 can also be used for molding other products of various different shapes and configurations.

Referring to FIG. 1, a first method for making a composite mold such as the composite mold 10 is provided. The first method comprises the steps of:
(a) providing a first mold having a desired shape;
(b) placing a mixture comprising tungsten carbide particles 101 and carbon nanocapsules 102 into the first mold;
(c) applying a pressing force so as to compress the tungsten carbide particles 101 and carbon nanocapsules 102 to be tightly held together; and
(d) sintering the mixture of tungsten carbide particles 101 and carbon nanocapsules 102, forming the composite mold 10 having the molding surface 110.

The first mold is made of a hard metallic alloy. A percentage by weight of the carbon nanocapsules 102 in the mixture is generally configured to be in the range from 1% to 25%, and preferably in the range from 1% to 13%. The carbon nanocapsules 102 can be provided by DC arc discharge in an inert gas between a set of graphite electrodes or metal-graphite electrodes. Accordingly, the carbon nanocapsules 102 are formed to be either hollow or filled with metal particles. Particle sizes of the carbon nanocapsules 102 are in the range from 1 nm to 100 nm, and preferably in the range from 30 nm to 40 nm.

Referring to FIG. 2, a second method for making a composite mold such as the composite mold 20 is provided. The second method is similar to the first method described above. However, in step (b) of the second method, the mixture further comprising noble metal particles 201.

A percentage by weight of the noble metal particles 201 in the mixture is generally configured to be in the range from 1% to 25%, and preferably in the range from 1% to 13%. The particle sizes of the noble metal particles 201 are in the range from 1 nm to 100 nm. The noble metal particles 201 may be selected from the group consisting of Pt, Re, Ir, and alloys thereof; for example, a Pt—Ir alloy, an Ir—Re alloy, or a Pt—Ir—Re alloy.

In addition, the first method and the second method for making a composite mold may each further comprise the step of micro-machining the molding surface according to a desired shape and configuration of a glass article to be produced.

The composite mold has a composite structure made of a sintered material formed by sintering carbon nanocapsules and tungsten carbide particles. Therefore the composite mold has high hardness and high mechanical strength, and ability to endure stresses at high temperatures. In addition, the process for making the composite mold is simplified, because there is no need to form a protective layer. Furthermore, due to the carbon nanocapsules provided in the composite structure, the following further advantages are obtained. The wear resistance of the composite mold is enhanced, and the molding surface has good workpiece release performance. Thus, chipping and peeling of the composite mold are avoided, with there being no need for an additional protective layer. Moreover, due to the noble metal particles provided in the composite structure, good surface smoothness of the composite mold is obtained, and the workpiece release performance is improved. This means that the service lifetime of the composite mold may be prolonged.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A composite mold having a composite structure comprised of a sintered material formed by sintering a mixture comprising tungsten carbide particles and carbon nanocapsules, the composite structure defining a molding surface.

2. The composite mold in accordance with claim 1, wherein a percentage by weight of the carbon nanocapsules in the sintered material is in the range from 1% to 25%.

3. The composite mold in accordance with claim 2, wherein the percentage by weight of the carbon nanocapsules in the sintered material is in the range from 1% to 13%.

4. The composite mold in accordance with claim 1, wherein the carbon nanocapsules are hollow or filled with metal particles.

5. The composite mold in accordance with claim 1, wherein particle sizes of the carbon nanocapsules are in the range from 1 nm to 100 nm.

6. The composite mold in accordance with claim 5, wherein the particle sizes of the carbon nanocapsules are in the range from 30 nm to 40 nm.

7. The composite mold in accordance with claim 1, wherein the mixture further comprises noble metal particles.

8. The composite mold in accordance with claim 7, wherein a percentage by weight of the noble metal particles in the sintered material is in the range from 1% to 25%.

9. The composite mold in accordance with claim 8, wherein the percentage by weight of the noble metal particles in the sintered material is in the range from 1% to 13%.

10. The composite mold in accordance with claim 7, wherein the noble metal particles are comprised of a material selected from the group consisting of Pt, Re, Ir, and alloys thereof.

11. The composite mold in accordance with claim 7, wherein the particle sizes of the noble metal particles are in the range from 1 nm to 100 nm.

12. A method for making a composite mold, comprising the steps of: providing a first mold;
placing a mixture comprising tungsten carbide particles and carbon nanocapsules into the first mold; and
sintering the mixture so as to form a composite mold having a composite structure with a molding surface.

13. The method for making a composite mold in accordance with claim 12, wherein the first mold is made of a hard metallic alloy.

14. The method for making a composite mold in accordance with claim 12, wherein a percentage by weight of the carbon nanocapsules in the mixture is in the range from 1% to 25%.

15. The method for making a composite mold in accordance with claim 12, wherein the carbon nanocapsules are hollow or filled with metal particles.

16. The method for making a composite mold in accordance with claim 12, wherein particle sizes of the carbon nanocapsules are in the range from 1 nm to 100 mn.

17. The method for making a composite mold in accordance with claim 12, wherein the mixture further comprises noble metal particles.

18. The method for making a composite mold in accordance with claim 17, wherein a percentage by weight of the noble metal particles in the mixture is in the range from 1% to 25%.

19. The method for making a composite mold in accordance with claim 17, wherein the noble metal particles are comprised of a material selected from the group consisting of Pt, Re, Ir, and alloys thereof, and have particle sizes thereof in the range from 1 nm to 100 nm.

20. The method for making a composite mold in accordance with claim 12, further comprising the step of micro-machining the molding surface according to a desired configuration of a product to be made by using the composite mold.
